(19) United States
(12) Patent Application Publication
(10) Pub. No.: US 2009/0240576 A1
(43) Pub. Date: Sep. 24, 2009

(54) METHODS, MEDIA, AND SYSTEMS FOR SELECTIVELY DISPLAYING ADVERTISING MATERIALS WITH USER GENERATED CONTENT

(75) Inventors: Charles Scott Rothrock, Oakton, VA (US); Christopher M. Schroeder, Bethesda, MD (US); Luke Adams, Charlotte Hall, MD (US)

Correspondence Address: WILMERHALE/DC, 1875 PENNSYLVANIA AVE., NW, WASHINGTON, DC, 20006, US

(73) Assignee: The HealthCentral Network, Inc., Arlington, VA (US)

(21) Appl. No.: 12/050,667

(22) Filed: Mar. 18, 2008

(51) Int. Cl. G06Q 30/00

(52) U.S. Cl. 705/14

(57) ABSTRACT

A method for selectively displaying advertising materials includes receiving an advertising material and an associated advertising rule, wherein the advertising rule specifies a restriction on user generated content that can be displayed together with the advertising material, and receiving user generated content via a network. The method further includes determining if the user generated content violates the advertising rule, and if the user generated content violates the advertising rule, generating a web page containing the user generated content without the advertising material.

### TECHNOLOGY AREA

A non-limiting embodiment of the invention relates to methods, media, and systems for managing advertisements at web sites with user generated content.

### BACKGROUND

In one implementation, user generated content may include various kinds of media content that an end-user of a network (e.g., the Internet) creates. User generated content may appear in bulletin board systems, news groups, end-user web sites (such as blogs), commercial web sites that invite user reviews, social networking web sites, and the like. It may include a variety of media types, such as digital audio, video or still images, text messages, web pages, free software, and/or a combination of these media. Millions of people worldwide produce, search for and consume user generated content every day for entertainment, education, and other purposes.

With the increase of network use by end-users, advertisers are increasingly advertising their products and services on network sites. An advertiser may find certain sites particularly suitable for advertising if end-users visiting these sites generally are interested in the types of products or services being advertised. For example, at a web-based bulletin board system where end-users discuss health-related issues, a pharmaceutical company may advertise for a new drug that the company is selling.

However, advertising at sites that host user generated content has certain risks. For example, the advertiser has no control over the user generated content displayed on a site before the content is published on the site, and while the host of the site may have some ability to monitor user generated content after it is displayed, in general, it does not evaluate or edit the content before it is displayed. Additionally, advertising is often delivered via a separate set of processes and systems that are not tightly integrated with the system managing user generated which makes controlling what advertising appears next to user generated content difficult.

Therefore, the advertiser and the site host typically cannot predict what content will be displayed next to an advertisement. As such, if an end-user posts a message that negatively describes a certain product, displaying an advertisement for that product next to the message can be more detrimental than not displaying the advertisement. Furthermore, displaying an advertisement for a competing product when a user posts a positive message about an advertiser's product would be detrimental to the advertiser.

Also, placing an advertisement next to certain user generated content may create legal or regulatory issues for the advertiser. For instance, in the United States, the Food and Drug Administration has strict laws and regulations governing the reporting of drug interactions. As such, if an end-user's message about a drug is displayed next to an advertisement for the drug, the host of the site and/or the drug manufacturer may have certain regulatory or monitoring obligations. Therefore, a method for selectively displaying advertisements with user generated content may be helpful so that a site can automatically refrain from displaying certain advertisement under certain circumstances.

### SUMMARY

Some embodiments of the present invention overcome the disadvantages and problems identified above. Other embodiments overcome other disadvantages and problems, and yet other embodiments do not overcome any disadvantages or problems.

One non-limiting embodiment relates to a method for selectively displaying advertising materials. The method includes receiving an advertising material and an associated advertising rule, wherein the advertising rule specifies a restriction on user generated content that can be provided together with the advertising material, and receiving user generated content. The method further includes determining if the user generated content violates the advertising rule, and if the user generated content violates the advertising rule, generating a web page containing the user generated content without the advertising material.

Another non-limiting embodiment relates to a computer program product for selectively displaying advertising materials. The product includes at least one computer readable medium, and instructions, provided on the at least one computer readable medium, for receiving an advertising material and an associated advertising rule, wherein the advertising rule specifies a restriction on user generated content that can be provided together with the advertising material. The product further includes instructions, provided on the at least one computer readable medium, for receiving user generated content. In addition, the product includes instructions, provided on the at least one computer readable medium, for determining if the user generated content violates the advertising rule, and instructions, provided on the at least one computer readable medium, for generating a web page containing the user generated content without the advertising material if the user generated content violates the advertising rule.

Yet another non-limiting embodiment relates to a system for selectively displaying advertising materials. The system includes a network interface configured to receive an advertising material and an associated advertising rule, wherein the advertising rule specifies a restriction on user generated content that can be provided together with the advertising material. The network interface also receives user generated content. The system further includes a processor configured to determine if the user generated content violates the advertising rule. If the user generated content violates the advertising rule, the processor is configured to generate a web page containing the user generated content without the advertising material.

Other features and advantages will become apparent from the following detailed description, drawings, and claims.

### BRIEF DESCRIPTION OF THE DRAWINGS

The detailed description, including the description of various embodiments of the invention, will be best understood when read in reference to the accompanying figures wherein:

FIG. 1 is a diagram providing an overview of a system according to various embodiments of the present invention;

FIG. 2 is flow diagram illustrating a method according to various embodiments of the present invention; and

FIG. 3 is a block diagram illustrating a server system according to various embodiments of the present invention.

### DETAILED DESCRIPTION

Some exemplary embodiments of the present invention provide systems, methods, and media that can be used for hosting web sites that selectively advertise materials on web pages in accordance with rules and/or restrictions associated with the advertising materials. By providing the rules and/or restrictions, an advertiser or web site host can avoid presenting an advertisement on a web page together with certain user generated content when such presentation is undesirable or presents regulatory concerns.

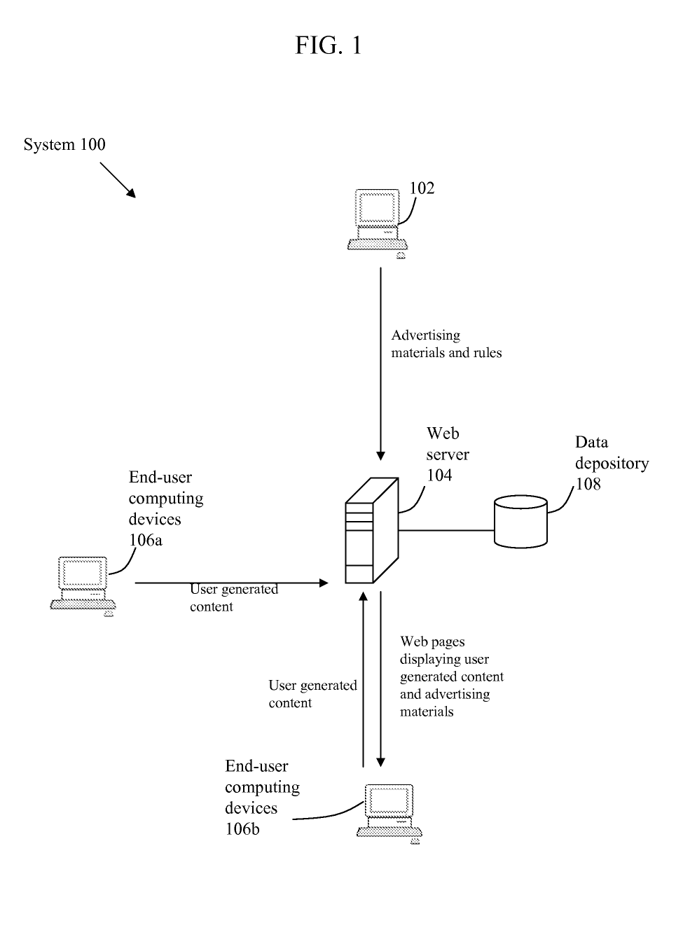

FIG. 1 illustrates a system 100 according to an illustrative, non-limiting embodiment of the present invention. The system 100 can be used for managing and presenting user generated content and advertising materials at a web site. As shown, the system 100 can include end-user computing devices 106a, 106b that end-users use to create user generated content. The devices 106a, 106b can send the user generated content (e.g., postings to an electronic bulletin board system) via electronic messages or data to a web server 104 that hosts the web site. The system 100 can also include a computing device 102 that an advertiser uses to send advertising materials and advertising rules to the web server 104. Also, the web server 104 can be connected to a data depository or database 108 for storing the user generated content, advertising materials, and rules, and communications between the web server 104 and the devices 102, 106a, 106b can be achieved using, for example, Internet connections.

The advertising materials sent by the computing device 102 can include, for example, still images, video images, audio clips, text information, animations, applets, links to other web sites, and/or any other material suitable for presentation in connection with a web page. Also, the advertising material may be associated with an advertising rule that the advertiser also provides, and the advertising rule can specify conditions under which the advertising material should be or should not be presented. In some embodiments, the advertising rule restricts the user generated content that can be displayed together with the advertising material. Also, in another implementation, the host or owner of the web site or a third party may upload the rule for the server 104.

The web server 104 may generate web pages that display user generated content. Upon receiving a request for a web page from an end-user computing device (e.g., device 106b), the web server 104 may send the generated web page to the device 106b. If the owner of the web site has agreed to place an advertisement on the web site for an advertiser, the web server 104 may compare the user generated content with the appropriate advertising rule to determine whether or not to incorporate the advertisement into the web page that displays the user generated content. If the user generated content violates the rule, the web server 104 refrains from incorporating the advertisement into the web page containing the user generated content. In this event, the web server 104 may also notify the advertiser (e.g., via electronic mail or other electronic or automated communication) that the advertisement was excluded from the web site. Alternatively or additionally, the server 104 may notify the host or owner of the web site or may notify the end user or notify a third party providing the advertising rule. A government agency is a non-limiting example of a third party that may be notified.

In one embodiment, the advertising rule includes a list of key words or phrases and specifies that the associated advertising material cannot be presented together with user generated content that includes at least one of the key words or phrases, and/or certain combinations of the words or phrases in the list. In addition to key words or phrases, the advertising rule may also evaluate various stems, conjugations, or tenses of key words. For example, an advertisement for a drug can be accompanied with, or correspond to, an advertising rule having a list including the brand or product name of the drug being advertised. The rule can specify that the advertisement should not be displayed together with user generated content that happens to include the brand or product name of the drug. Hence, if an end-user posts to the web site an inquiry about the drug, the advertising rule can prevent the advertisement from being displayed or otherwise presented together with the end-user inquiry or a response to the inquiry. This can help the advertiser, web site host or owner, or thirty parties avoid potential marketing, legal, or regulatory issues. If certain user generated content to be presented in a web page does not violate the advertising restrictions, the web server 104 can create a web page including both the user generated content and the advertisement and send the web page to user who requested it.

To determine whether certain user generated content includes a particular word or phrase relating to an advertising rule, the web server 104 can scan the user generated content in search for the word or phrase. In one embodiment, the web server 104 first “tokenizes” words in the user generated content using punctuations and white spaces, and then attempts to match the word exactly with tokenized words in the user generated content. For example, the word “aspirin” would be found in the user generated content “I took an aspirin and went to sleep,” but would not be found in “I took two XaspirinX.” Alternatively, partial word matching may be used, so that “aspirin” can be found in the passage “I took two aspirins.” Matching of words can also be performed in a case insensitive manner, so that words such as “AsPiRiN” or “Aspirin” also matches “aspirin.” If the user generated content is stored in a database, certain functionalities provided by the database can be utilized for determining whether the user generated content contains a certain word. For example, if the user generated content is stored in a MySQL database, MySQL's Full-Text Searching in Boolean mode can be utilized to search for a word in the content. In addition, the functionalities may be used to determine whether the user generated content contains stems, conjugates, different tenses, etc. of a certain word. For instance, if one of the key words of a rule is “diet,” the functionalities may determine whether or not the content includes the word “dietary,” “dieting,” “dieted,” etc. Moreover, the functionalities may determine whether or not the user generated content contains synonyms or antonyms of a particular word.

As noted above, the web server 104 can be connected with a data repository or database 108. The repository 108 can include hardware and software for storing advertising materials, advertising rules, user generated content, web pages, and/or any other information or data. The repository 108 can be located, for example, in a storage area network (not shown) coupled to the web server 104, and can include, for example, a standard database for storing information.

In some embodiments, the repository 108 can be used to store, for each unit of user generated content, an exclusion field specifying advertising materials that cannot be displayed with the user generated content. For example, when the web server 104 receives units of user generated content, they can each be stored in the repository 108, and an exclusion field can be created and stored in the repository 108 for each unit of the user generated content. When advertising material and advertising rules are received from advertisers or other sources, each unit of user generated content can be analyzed against the advertising rules to determine whether or not each advertising material can be presented together with the user generated content unit. The exclusion fields are then updated so that each exclusion field specifies advertising materials that cannot be presented together with the associated content unit. Hence, when a number of user generated content units are selected to be included in a web page, the web sever 104 can examine the exclusion fields associated with the content units and quickly determine which advertisements should be excluded from the web page.

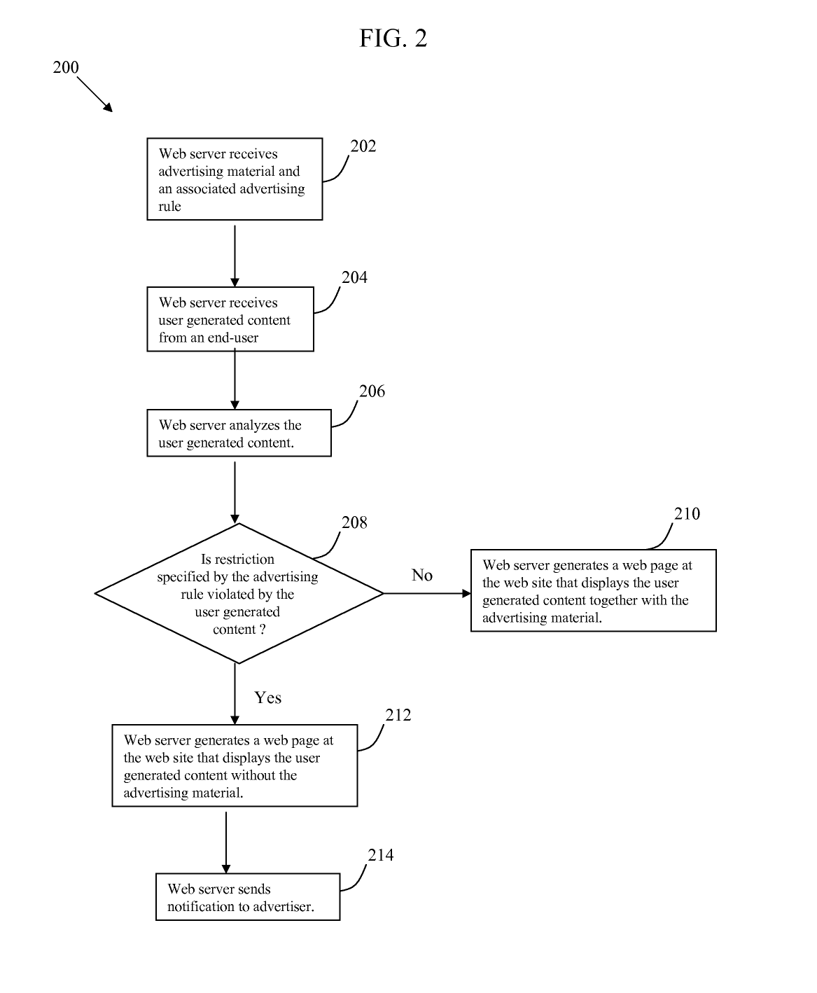

FIG. 2 is a flow diagram illustrating a method 200 according to an exemplary non-limiting embodiment of the present invention. The method 200 allows the web server 104 to provide a web site that selectively displays advertising materials with user generated content. At operation 202, the web server 104 can receive advertising material and an associated advertising rule from an advertiser or other sources. The advertising rule may specify a restriction regarding the user generated content that can be displayed together with the advertising material. At operation 204, the web server 104 receives user generated content (e.g., a posting to a web-based bulletin board system) that can be included in one or more electronic messages or other data communications from one or more end-users.

At operation 206, the server 104 compares the user generated content with the advertising rule. If the user generated content violates the restriction specified by the advertising rule (e.g., the user generated content includes a word that is blacklisted in the advertising rule), in operation 208, the web server 104 generates a web page at the web site that displays the user generated content without the advertising material in operation 212, and notifies this exclusion to the advertiser, web site host or owner, end user, or third party (operation 214). Otherwise, at operation 210, the web server 104 generates a web page at the web site that displays the user generated content together with the advertising material.

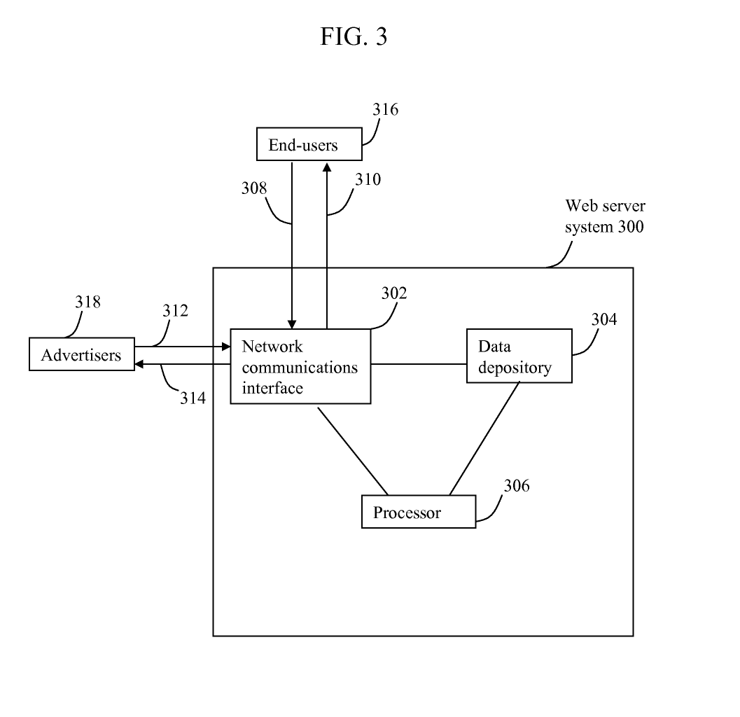

FIG. 3 is a block diagram of a web server system 300 according to another non-limiting embodiment of the present invention. The system 300 can be used to host a web site that selectively displays user generated content and advertising material, under the control of the advertisers. As shown, the system 300 can include a network communications interface 302 for sending and receiving data. The arrow 308 represents data sent to the system 300 by end-users 316, and the data may include messages containing user generated content and requests for web pages. The arrow 310 represents data sent by the system 300 to the end-users 316, and the data may include web pages generated by the system 300. The arrow 312 represents data sent to system 300 by the advertisers 318, and the data may include advertising materials and advertising rules. The arrow 314 represents data sent by the system 300 to the advertisers 318, such as notifications indicating exclusions of advertising materials in certain web pages.

The system 300 can also include a processor 306 and a data repository or database 304. The data repository 304 can be used for storing the received advertising materials and advertising rules, user generated content, information relating to exclusions of advertising materials, and/or any other information or data. The processor 306 can be configured to analyze units of user generated content to determine whether the units conform to or violate the restrictions specified by received advertising rules. Also, the processor 306 can generate a web page at the web site that displays the user generated content units together with advertising materials, upon determining that the user generated content units do not violate the restrictions specified by the associated advertising rules. If the restrictions are violated, the processor 306 may prevent certain advertising materials from being displayed in the web pages.

The above description has referred to systems, databases, processors, and servers. These terms should be understood broadly to cover a wide range of hardware and/or software that can be used to implement these components. The various servers and/or systems could be implemented substantially all in hardware or software, but would typically be implemented primarily with software executed on a processor. A processor or server can be a general purpose device, or could be application-specific. In the description above, there are references to data repositories and databases, but any form of memory that is suitable to hold the data could be used.

Also, in some of the non-limiting embodiments, data is exchanged over the Internet. Clearly, other embodiments can be used on other types of networks such as Local Area Networks (LANs), wireless networks, and any other suitable networks that support data communication. Also, some of the embodiments transmit the advertising materials, rules, and user generated content to the web server 104 via network communications. However, in other embodiments, a user may locally load the advertising materials, rules, and/or content onto the 104 or data repository 108.

Other embodiments, extensions, and modifications of the ideas presented above are comprehended and within the reach of one skilled in the field upon reviewing the present disclosure. Accordingly, the scope of the present invention in its various aspects is not to be limited by the examples and embodiments presented above. The individual aspects of the present invention, and the entirety of the invention are to be regarded so as to allow for modifications and future developments within the scope of the present disclosure. The present invention is limited only by the claims that follow.

1. A method for selectively displaying advertising materials, comprising:
receiving an advertising material and an associated advertising rule, wherein the advertising rule specifies a restriction on user generated content that can be provided together with the advertising material;
receiving user generated content;
determining if the user generated content violates the advertising rule; and
if the user generated content violates the advertising rule, generating a web page containing the user generated content without the advertising material.

2. The method of claim 1, wherein the receiving user generated content comprises receiving the user generated content via a network.

3. The method of claim 1, wherein the advertising rule comprises a list of words and/or phrases, wherein the restriction indicates that the advertising material cannot be provided together with user generated content that includes at least one word or phrase in the list, and wherein the determining comprises comparing each word or phrase in the list against words and/or phrases in the user generated content.

4. The method of claim 3, wherein the list of words and/or phrases comprises brand or product names.

5. The method of claim 3, wherein the comparing comprises a case insensitive comparison.

6. The method of claim 1, further comprising sending to an advertiser information relating to whether the advertising material is provided together with the user generated content.

7. The method of claim 6, wherein the sending comprises sending the information via an electronic communication.

8. The method of claim 1, wherein the web page generated contains a bulletin board comprising user messages that share a common topic.

9. The method of claim 1, further comprising storing in a data depository the received advertising material, the received user generated content, and an exclusion field associated with the user generated content specifying advertising materials that cannot be provided with the user generated content.

10. A computer program product for selectively displaying advertising materials, comprising:
at least one computer readable medium;
instructions, provided on the at least one computer readable medium, for receiving an advertising material and an associated advertising rule, wherein the advertising rule specifies a restriction on user generated content that can be provided together with the advertising material;
instructions, provided on the at least one computer readable medium, for receiving user generated content;
instructions, provided on the at least one computer readable medium, for determining if the user generated content violates the advertising rule; and
instructions, provided on the at least one computer readable medium, for generating a web page containing the user generated content without the advertising material if the user generated content violates the advertising rule.

11. The computer program product of claim 10, wherein the instructions for receiving user generated content comprise instructions for receiving the user generated content via a network.

12. The computer program product of claim 10, wherein the advertising rule comprises a list of words and/or phrases, wherein the restriction indicates that the advertising material cannot be provided together with user generated content that includes at least one word or phrase in the list, and wherein the determining comprises comparing each word or phrase in the list against words and/or phrases in the user generated content.

13. The computer program product of claim 12, wherein the list of words and/or phrases comprises brand or product names.

14. The computer program product of claim 12, wherein the comparing comprises a case insensitive comparison.

15. The computer program product of claim 12, further comprising instructions, provided on the at least one computer readable medium, for sending to an advertiser information relating to whether the advertising material is provided together with the user generated content.

16. The computer program product of claim 15, wherein the sending comprises sending the information via an electronic communication.

17. The computer program product of claim 12, wherein the web page generated contains a bulletin board comprising user messages that share a common topic.

18. The computer program product of claim 12, further comprising instructions, provided on the at least one computer readable medium, for storing in a data depository the received advertising material, the received user generated content, and an exclusion field associated with the user generated content specifying advertising materials that cannot be provided with the user generated content.

19. A system for selectively displaying advertising materials, comprising:
a network interface configured to receive an advertising material and an associated advertising rule, wherein the advertising rule specifies a restriction on user generated content that can be provided together with the advertising material, and receive user generated content; and
a processor configured to determine if the user generated content violates the advertising rule, and if the user generated content violates the advertising rule, generate a web page containing the user generated content without the advertising material.

20. The system of claim 19, wherein the network interface receives the user generated content via a network.

21. The system of claim 19, wherein the advertising rule comprises a list of words and/or phrases, wherein the restriction indicates that the advertising material cannot be provided together with user generated content that includes at least one word or phrase in the list, and wherein the processor compares each word or phrase in the list against words and/or phrases in the user generated content.

22. The system of claim 21, wherein the list of words and/or phrases comprises brand or product names.

23. The system of claim 21, wherein the processor performs a case insensitive comparison of each word or phrase in the list against the words and/or phrases in the user generated content.

24. The system of claim 21, wherein the network interface is further configured to send to an advertiser information relating to whether the advertising material is provided together with the user generated content.

25. The system of claim 24, wherein the network interface is configured to send the information via an electronic communication.

26. The system of claim 21, wherein the web page generated contains a bulletin board comprising user messages that share a common topic.

27. The system of claim 21, further comprising a data depository configured to store the received advertising material, the received user generated content, and an exclusion field associated with the user generated content specifying advertising materials that cannot be provided with the user generated content.
